(19) United States
(12) Patent Application Publication
(10) Pub. No.: US 2013/0306646 A1
(43) Pub. Date: Nov. 21, 2013

(54) Nested Cookware Set

(71) Applicant: Stanley Kin Sui Cheng, Hillsborough, CA (US)

(72) Inventor: Stanley Kin Sui Cheng, Hillsborough, CA (US)

(73) Assignee: MEYER INTELLECTUAL PROPERTIES LTD., Kowloon (HK)

(21) Appl. No.: 13/875,049

(22) Filed: May 1, 2013

Related U.S. Application Data
(60) Provisional application No. 61/648,365, filed on May 17, 2012.
(60) Provisional application No. 61/650,384, filed on May 22, 2012.
(60) Provisional application No. 61/699,110, filed on Sep. 10, 2012.

(51) Int. Cl. A47J 27/13

(52) U.S. Cl. CPC A47J 27/13
USPC 220/573.5

(57) ABSTRACT

A set of cooking vessels includes 2 or more fluid containing vessels that nest within each other for compact storage. Side gripping handles on opposing sides of the vessel also and asked with each other, as the larger vessel has cite handles with a laterally extending cavity that accommodates the contour of the smaller vessel handles which are mere extension of the rim thereof. The vessel set may also accommodate a sieve or strainer that nest within the smaller vessel, as well as a third nestable vessel that can optionally be used as a lid to cover the larger vessel during cooking.

### CROSS REFERENCE TO RELATED APPLICATIONS

This application claims the benefit of priority to the following U.S. Provisional patent applications, having serial numbers: 61/699,110 (filed Sep. 10, 2012), 61/650,384 (filed May 22, 2012) and 61/648,365 filed May 17, 2012, which are all incorporated herein by reference.

### BACKGROUND OF INVENTION

The present field of invention is cookware, and more particularly nested cookware vessels.

Prior methods of nesting cookware are known, however they lack versatility.

Furthermore, the handles of such cookware sets, unless removable, will increase the required storage space for the set, or alternatively provide less potential foodstuff volume in the individual cookware vessels.

Further, the use of single removable handle that fits multiple pieces in the set precludes or makes very cumbersome the simultaneous use of more than 2 vessels in the set.

It is therefore a first object of the present invention to provide to provide a set of nesting cookware vessel that overcome the above and other disadvantages of the prior art sets of stacked cookware.

### SUMMARY OF INVENTION

In the present invention, the first object is achieved by providing a cookware vessel set comprising a first cooking vessel, having a first bottom surface with first upward extending walls connected thereto that terminate at a first rim, a second cooking vessel, having a second bottom surface with second upward extending walls connected thereto that terminate at a second rim, and a first laterally extending flange connecting to the second rim, wherein the second cooking vessel is smaller than the first cooking vessel and the second rim thereof is smaller than the first rim such that second cooking vessel can nest upright in the first cooking vessel, a third vessel having a third bottom surface with third upward extending walls connected thereto that terminate at a third rim, and a third laterally extending annular flange that connected to the third rim, wherein at least one of the third rim and third laterally extending annular flange of the third vessel has at least an annular portion capable of overlapping the second rim and the first rim when disposed thereon in an inverted position to act as a lid.

A second aspect of the cookware set of the present invention is characterized in that the first and at least one of the first and second vessels have handles that interlock in both upright and inverted position to substantially sealing mate the respective flanges of each vessel and preclude lateral motion there between.

Another aspect of the cookware set of the present invention is characterized in that the second vessel is at least partially perforated at the bottom thereof to provide a removable sieve or steamer insert.

Another aspect of the cookware set of the present invention is characterized in that each of the first second and third vessels has pairs of handles latterly disposed and connected to at least one of the portion of the sidewall and the rim of the respective vessel, each handle in the pair disposed on the opposite side of the vessel.

Another aspect of the cookware set of the present invention is characterized in that the pair of handles of the first vessel includes an aperture adapted to receive both the handles of the second vessel when the second vessel is vested in upright position in the first vessel.

Another aspect of the cookware set of the present invention is characterized in that the pair of handles of the third vessel is adapted to be received in a stable mating engagement with the combination of the aperture and handles of the first vessel at the second vessel when inverted for storage or use as a steam containing lid on either the first and second vessel.

Another aspect of the cookware set of the present invention is characterized in that the third vessel is a sieve having a plurality of perforations on the third bottom surface.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1A is a cross-sectional elevation view of an embodiment of the cookware vessel set in a first nested condition, whereas FIG. 1B is a split cross-sectional elevation view of this embodiment of the cookware vessel set in second configuration. FIG. 1C is a detailed view of the handle portion of the vessels in the set at their common junction, whereas FIG. 1D is a detailed view of an orthogonal portion of the vessels in the set at the junction of the rims.

FIG. 2A is a cross-sectional elevation view of another embodiment of the cookware vessel set in a different nested condition. FIG. 2B is a detailed view of the handle portion of the vessels in a first stage in nesting, whereas FIG. 2C is a detailed view of the handle portion of the vessels in a subsequent stage of nesting that inverts the top most vessel.

FIG. 3 is a top plan view of 2 components of the cookware set of FIG. 1.

FIG. 4 is a top plan view of 2 components of the cookware set of FIG. 2.

FIG. 5 is a perspective exploded view of the sieve/steamer support component and second vessel in the orientation for nested storage, both within the first or outer vessel of the cookware set.

FIG. 6 is a perspective exploded view of the sieve/steamer support component as oriented for use in which the second vessel is inverted to serve as a lid that extends over the steamer component and sealing engages the first or outer vessel.

FIG. 7 is a cross-sectional elevation view of another embodiment of the cookware vessel set.

### DETAILED DESCRIPTION

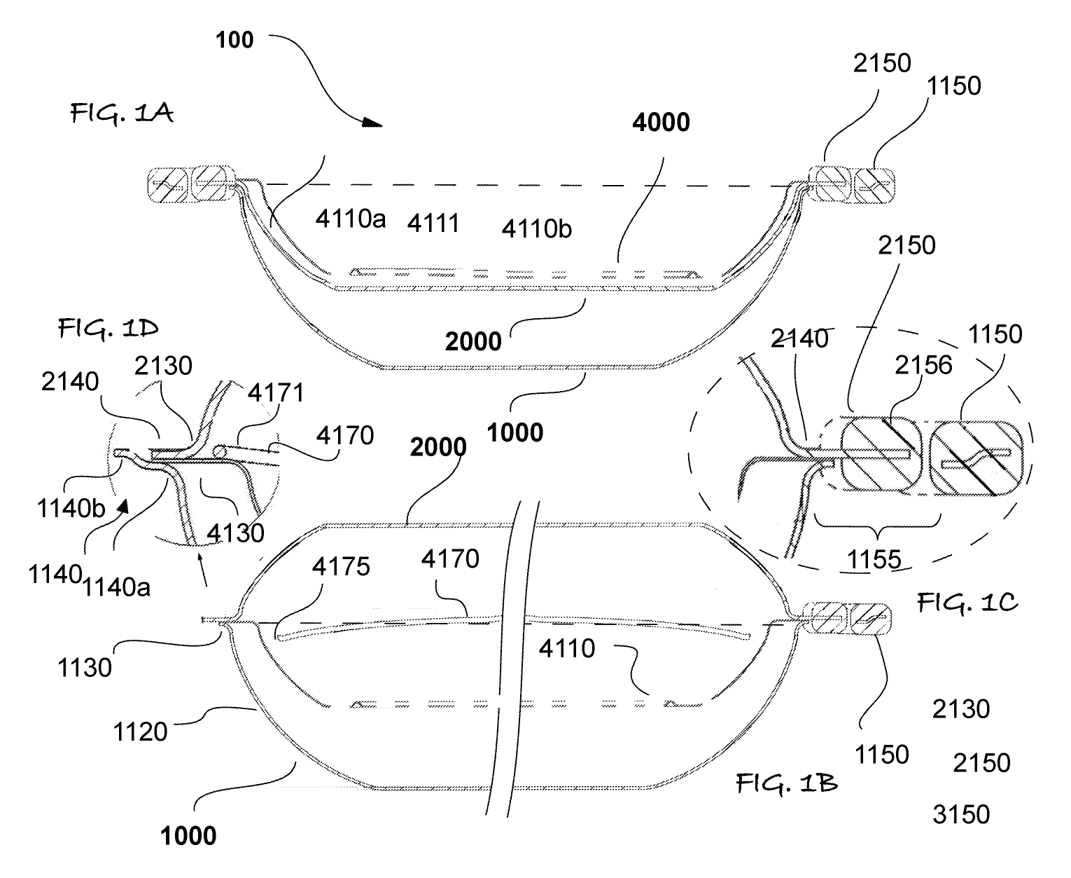

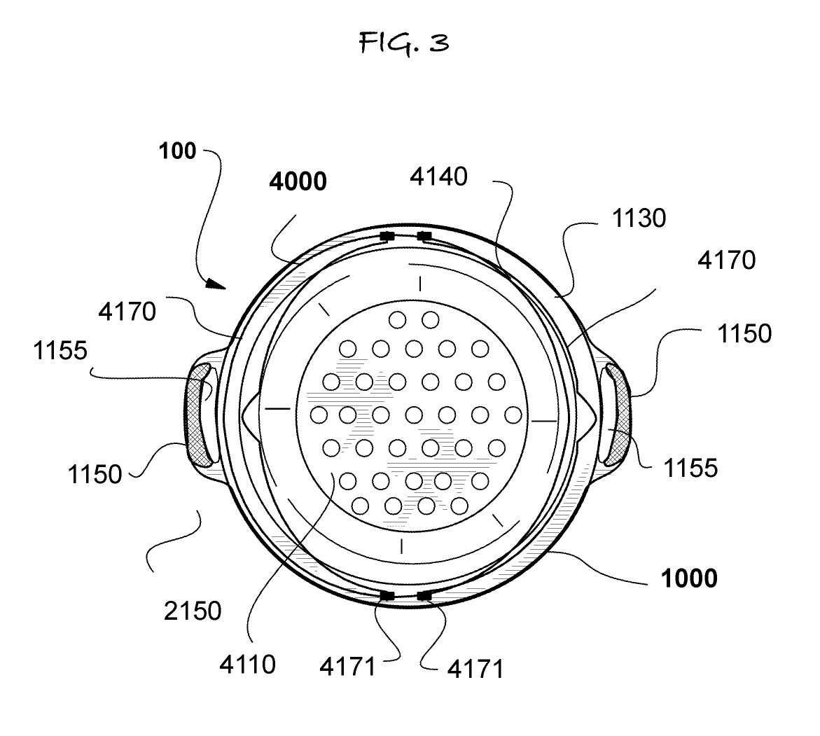

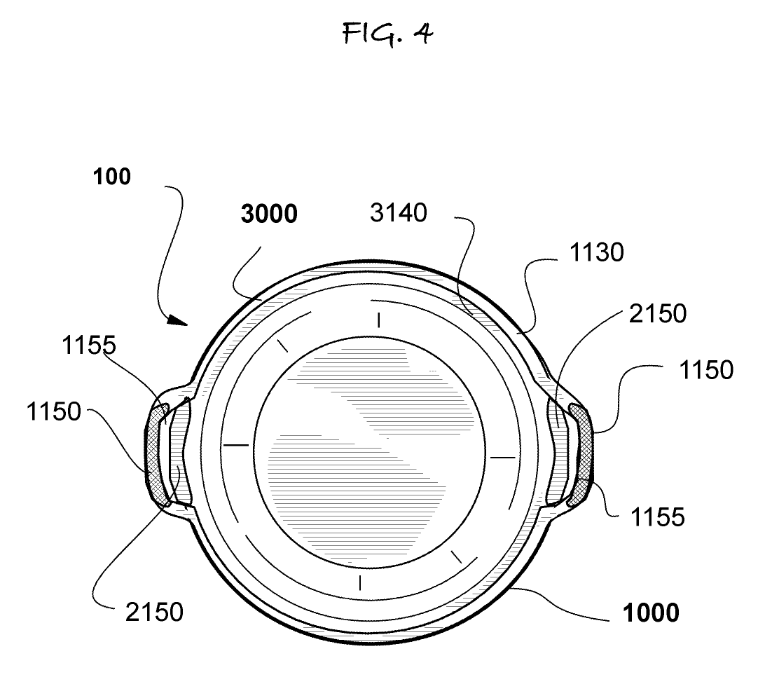

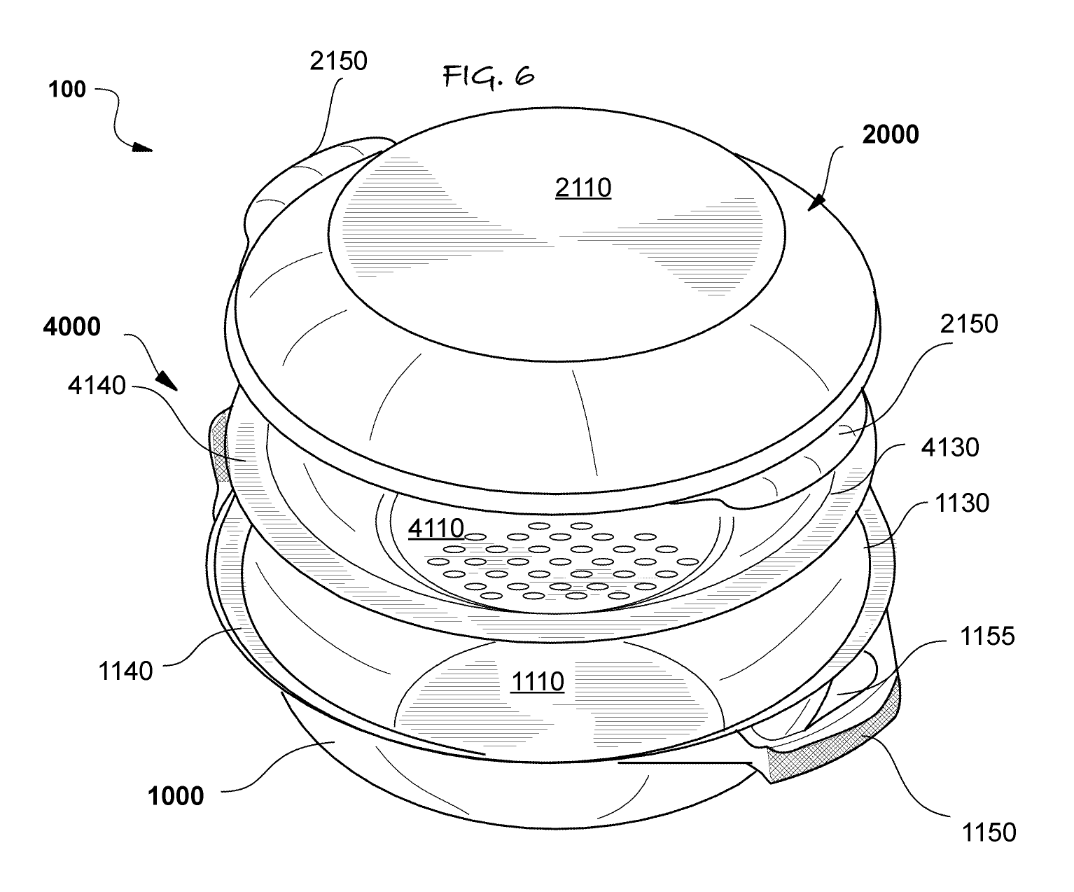

Referring to FIGS. 1 through 7, wherein like reference numerals refer to like components in the various views, there is illustrated therein a new and improved Nesting Cookware Set, generally denominated 100 herein.

In accordance with the present invention cookware set 100 comprises a first and second cookware vessel, each having a bottom surface (1110 for the first vessel 1000 and 2110 for the second vessel 2000) and connected surrounding sidewalls (1120 for the first vessel and 2120 for the second vessel) that extend upward and outward to a rim (1130 for the first vessel and 2130 for the second vessel), wherein an annular flange (1140 for the first vessel and 2140 for the second vessel) extends laterally about the rim. The first 1000 and second cookware vessels 2000 have handles (1150 for the first vessel and 2150 for second vessel) that extend outward from the flange formed adjacent to the rim portion. The first vessel 1000 is the largest and hence outer vessel in the nested set 100, whereas the other component vessel(s) is/are shorter and narrower (at least at the bottom thereof), to fit with the first or outer vessel 1000 for storage, as described in further below.

Within the first vessel 1100, the handle portion 1150 is optionally connected to the rim 1130, or any flange portion that extends there from, being generally horizontally flush with the rim 1130, and generally including at least a partial depression, perforation or aperture 1155. However, the handle 1150 can also extend outward from the upright sidewall of the vessel.

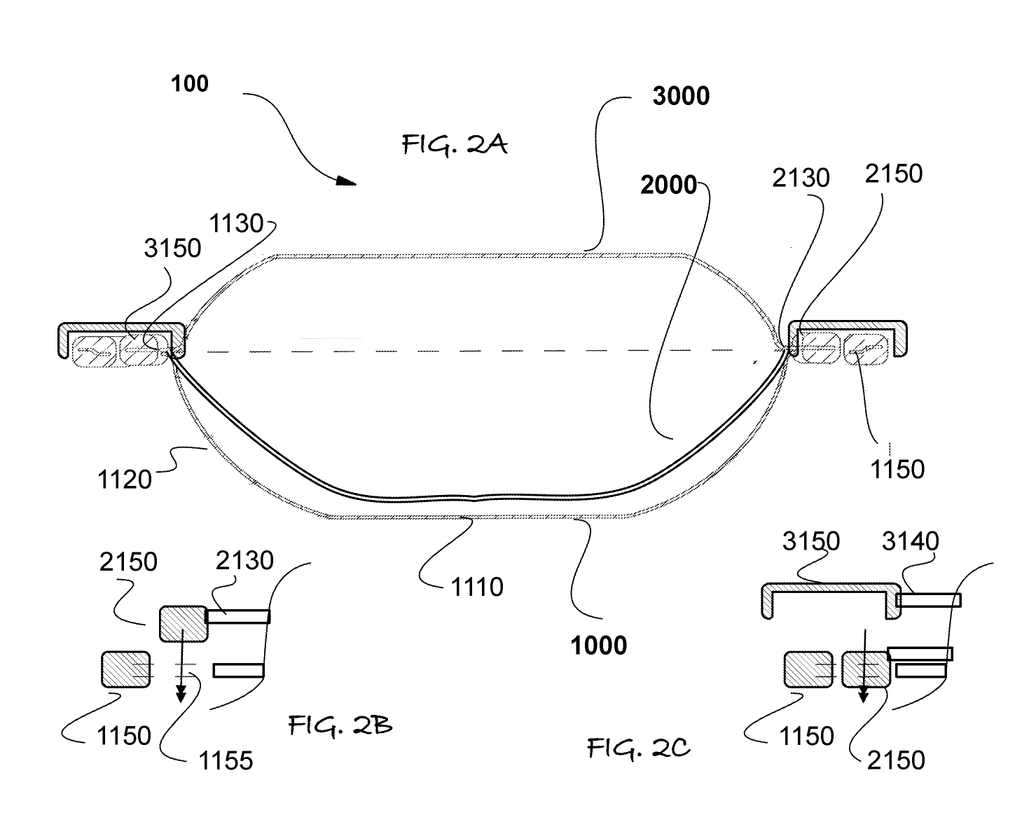

Within the second vessel 2000, the handles 2150 are optionally connected to the rim 2130, or any flange portion 2140 that extends from the rim, being generally horizontally flush there with. Hence, the narrower and shallower second vessel 2000, can be stored in a nesting configuration within the larger outer vessel 1000, in which the respective handles intermesh within each other so that the rim of each vessel is substantially in the same horizontal plane. As shown in FIGS. 1C and 2B, the handles of the first and second vessel intermesh or interlock to restrict the lateral motion of each vessel against the other, such movement being restrained by the vertical interference of the intermeshed fitting portion of the handles. Hence, as shown in the various embodiments, to the extent the handle of the first vessel 1150 has aperture 1150, a second or third, or other mating vessel can deploy a handle having at least a portion that enters the aperture 1150 and generally conforms to the aperture's lateral profile to restrain lateral motion once inserted.

Furthermore, the surrounding portion of each handle is preferably covered with a generally non-thermally conducting layer or coating (such as rubber, and preferably typically silicone rubber) which is preferably deployed to form vertical projections 2156, hence preventing the user's hands from contacting handle portion that become hot during use, so the vessel can be safely gripped by these handles.

Further, set 100 also preferably comprises a sieve/steamer support 4000, having a perforated bottom surface 4110 that is connected to surrounding sidewalls 4120, which extends outward and upward to a rim portion 4130. The rim portion 4130, which optionally includes an outward extending annular flange, has at least a portion that extends sufficiently outward to be disposed on the rim of either the first or second vessel, thus supporting the perforated bottom surface 4110 having holes (such as 4100a and/or 4110b) well above the bottom of the cookware vessel during use. Further, sieve 4000, can likewise be nested within set 100, being disposed above vessel 2000 as shown in FIG. 1A.

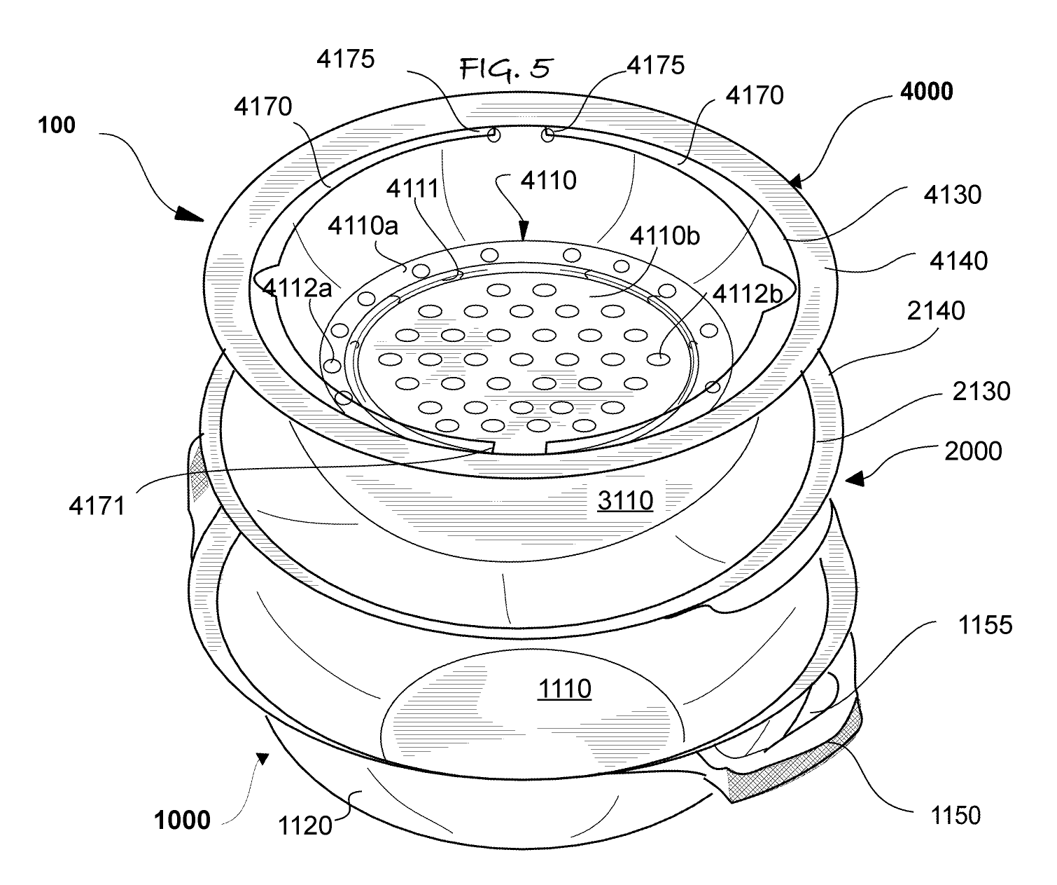

As shown in further detail in FIG. 5, sieve 4000 bottom surface 4110 has a raised circular ridge 4111 that is concentrically aligned therewith to divide the bottom surface 4110 into 2 regions, central region 4110a, and an annular region 4110b that surrounds the central region 4110at. Both these regions 4110a and 4110b have holes. The ridge 4111 forces dripping condensate to drain through the holes 4112a of the annular region 4110a, before this liquid can enter the inner region 4110a between holes 4112a, where it would excessively dampen foodstuff supported thereon.

The sieve component 4000 (as shown in FIG. 5) also preferably includes a pair of oppositely disposed wire handles 4170. Each of the wire handles 4170 in the pair has a generally semi-circular shape but for the end portions 4171 that extend radially from the circle perimeter to engage in an axle bore or coupling 4175 formed below the rim or flange of the sieve 4000, that is in wall 4120. The pairs of axle bores 4175 that receive the ends of the handle 4170 are adjacent to each other, with each pair on the opposite side of the rim from the other pair. This permits the handles to fold downward when the sieve 4000 is resting on the rim or flange of either vessel, generally falling just within the annular rim portion. However, by folding both pairs of handles upward from their resting position, the sieve 4000 and its content can be lifter up and away from the vessel for rinsing, removing and/or serving.

FIG. 1D illustrates the details of the interlocking rims distal from handle 1150 and 2150, corresponding with the left side of FIG. 1B. Flange 1140 of the first vessel 1000 has two concentric annular portion, the lower region 1140a being inward and connected to the side wall 1120 at rim 1130. A higher annular surrounding region 1140b is connected thereto by a partially vertical transition or slope to define a sealing annulus at portion 1140a for retaining both the flange 4120 of sieve 4000 and the horizontal annular flange 2140 of the second vessel when inverted to provide a lid over the outer vessel 1000 and the sieve 4000. The lower region 1140a sealingly support the flange 4140 of the sieve 4000, which in turn sealingly supports the flange of 2140 when vessel 2000 is inverted to provide a lid.

Alternatively, while the flange 2130 can laterally extend to rest on the upper annular flange portion 1140b, this is less preferred as it would not locking seat the lid to preventing it from laterally sliding off vessel 1000, absent adding another upward transition to a final raised outer annular on flange 1140.

FIG. 2A-C illustrates an alternative embodiment, which optionally can also include sieve 4000, or use vessel 2000 as a sieve (if perforated at the bottom 2110) as well as the use of a third vessel 3000, having a bottom 3110, with upward extending sidewalls 3120 that terminate at an annular rim 3140. A flange 3140 horizontal projects as an annular lateral extension from the periphery of rim 3140. The third vessel also has handles 3150 having a portion that is capable of matingly intermeshing with either the aperture 1155 in handle 1150, or extends around the outer perimeter thereof, as shown in FIG. 2C. Hence, the third vessel 3000 having a bottom surface 3100, sidewalls 3120 and a rim 3130, as well as handles 3150 is optionally included in the set, and in the stacked configurations shown FIGS. 1 and 2 is arranged as a lid that is inverted so that the rim 3130 sealingly engages the corresponding rim 1130 or 2130 of both the first and second vessels respectively.

Hence, FIG. 2A illustrates a storage position, or a means of using vessel 3000 as a lid with either vessel 100 or 2000. In this embodiment, handle 3150 in the inverted position surrounds both of handles 1150 and 2150, having a concave upper surface that conforms to the horizontal extent and vertical height of the combination of these 2 handles that themselves intermesh as shown FIG. 2B. Thus, while FIG. 2B illustrates the insertion of handle 2150 into the aperture 1155 in handle 1150, FIG. 2C, shows the overlaid placement of the concave portion of handle 2150 over the intermeshed combination of handles 2150 an 1150.

It should now be appreciated that the handles of the second vessel 2150 have an optimal size and shape to nest or be disposed within the cavity or aperture 1155 of the handle 1150 of the first or lower vessel 1000 in the set 100. More specifically, the aperture or hole 1150 in handle 1150 accepts a complementary shaped portion of the second vessel in an upward position for storage, but also accepts the complementary shape of the inverted third vessel 3000 when used as a lid. Furthermore, the second vessel when used for cooking also accepts the complementary shape of the inverted third vessel when used as a lid. Hence, at least the second vessel in both embodiments has a handle with a vertically projecting portion 2156 that is received in the aperture 1150 that extends both above and below the horizontal reference plane defined by the surface if the second vessel's flange 2140.

Hence the set of cookware described herein, and in particular as shown an described with respect to FIG. 2, provides in another embodiment as many as 3 separate cooking vessels, one of which can be used as an optional lid which is easy to securely seat and seal to the rim portions of either of the other vessels that optionally form part of the set 100.

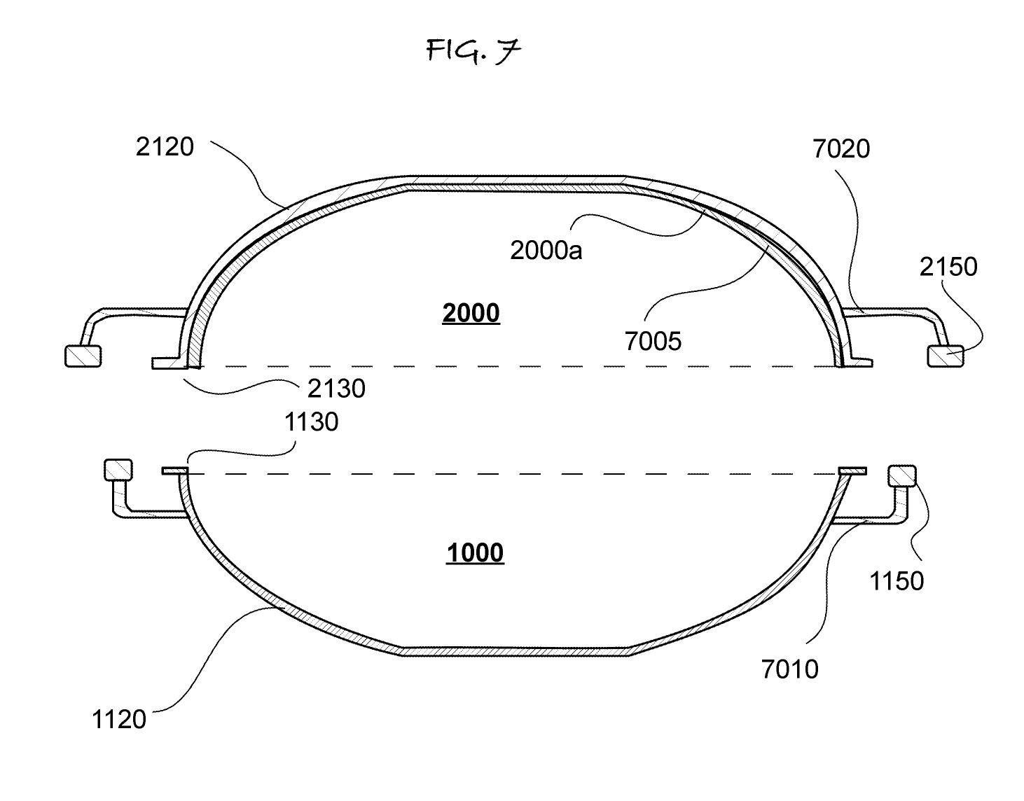

In another embodiment of the invention illustrated in FIG. 7, the upper cookware vessel 2000 that can serve as a lid for the lower cookware vessel 1000 has a non-stick coating 7005 deposited on the inside surface 2000a, and in particular a flouro-polymer or silicone polymer coatings. As such coating have limited durability when used for high temperature cooking, the user of the set has the option of high heat cooking in the first vessel, which is made optionally of cast iron, steel, stainless steel, aluminum or coated copper, included clad metal layers combining these and other material, but does not deploy a coating that would be susceptible to degradation at high cooking temperatures. In this embodiment, the handles 1150 and 2150 of each vessel are shown as optionally connected to the sidewall 1120 and 2020 respectively by discrete flanges 7010 and 7020, without any attempt to limit the application to other embodiment of handle attachment.

It should also be noted that the first, second and third cookware vessels of the present invention achieve the aforementioned objectives while also providing a useful wok like shape, that is the vessel width is substantially greater than the height, with the surrounding sidewalls 120 sloping upward from a smaller bottom 110 this is optionally curved or flat. It should be appreciated that in the foregoing discussion of the vessels shape, nothing precludes the merger of the sidewalls into the bottom, when the entire inner surface has continuously curving spherical or aspherical shape. However, because of the flush nesting configuration achieved by the progressive profile changes of the vessels in decreasing size from the bottom or outer vessel 1000, along with the interlocking handle portions that are generally flush with the rim, the configuration is both compact and stable. Such stability is also a benefit in that the vessel surface will not contact and potentially mar each other during shipping.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A cookware vessel set comprising:
a) a first cooking vessel, having a first bottom surface with first upward extending walls connected thereto that terminate at a first rim,
b) a second cooking vessel, having a second bottom surface with second upward extending walls connected thereto that terminate at a second rim, and a first laterally extending flange connecting to the second rim,
c) wherein the second cooking vessel is smaller than the first cooking vessel and the second rim thereof is smaller than the first rim such that second cooking vessel can nest upright in the first cooking vessel,
d) a third vessel having a third bottom surface with third upward extending walls connected thereto that terminate at a third rim, and a third laterally extending annular flange that connected to the third rim,
e) wherein at least one of the third rim and third laterally extending annular flange of the third vessel has at least an annular portion capable of overlapping the second rim and the first rim when disposed thereon in an inverted position to act as a lid.

2. A cookware set according to claim 1 wherein the first and at least one of the first and second vessel have handles that interlock in both upright and inverted position to substantially sealing mate the respective flanges of each vessel and preclude lateral motion there between.

3. A cookware set according to claim 1 wherein the second vessel is at least partially perforated at the bottom thereof to provide a removable sieve or steamer insert.

4. A cookware vessel set according to claim 1 wherein each of the first second and third vessels has pairs of handles latterly disposed and connected to at least one of the portion of the sidewall and the rim of the respective vessel, each handle in the pair disposed on the opposite side of the vessel.

5. Cookware vessel set according to claim 2 wherein the pair of handles of the first vessel includes an aperture adapted to receive both the handles of the second vessel when the second vessel is vested in upright position in the first vessel.

6. A cookware vessel set according to claim 2 wherein the pair of handles of the third vessel is adapted to be received in a stable mating engagement with the combination of the aperture and handles of the first vessel at the second vessel when inverted for storage or use as a steam containing lid on either the first and second vessel.

7. A cookware vessel set according to claim 1 wherein the third vessel is a sieve having a plurality of perforations on the third bottom surface.

8. A cookware vessel set comprising:
a) a first cooking vessel, having a first bottom surface with first upward extending walls connected thereto that terminate at a first rim,
b) a second cooking vessel, having a second bottom surface with second upward extending walls connected thereto that terminate at a second rim,
c) wherein the first and and second vessels have side handles that interlock in both upright and inverted position to substantially sealing mate the respective rims of each vessel and preclude lateral motion there between.
d) wherein the first vessel is metal and has an interior metallic finish and the second vessel is metallic and has an organic fluoro-polymer coating on the interior surface thereof.
e) wherein at least one of the third rim and third laterally extending annular flange of the third vessel has at least an annular portion capable of overlapping the second rim and the first rim when disposed thereon in an inverted position to act as a lid.
